(19) United States
(12) Patent Application Publication
(10) Pub. No.: US 2026/0252182 A1
(43) Pub. Date: Aug. 27, 2026

(54) ADJUSTABLE-FORCE JOYSTICK POTENTIOMETER

(71) Applicant: Guangdong Jinfu Intelligent Technology Co., Ltd, Dongguan (CN)

(72) Inventors: Guosheng ZENG, Dongguan (CN); Chengteng LIANG, Dongguan (CN); Shengkai HUANG, Dongguan (CN)

(21) Appl. No.: 19/251,010

(22) Filed: Jun. 26, 2025

(30) Foreign Application Priority Data
Feb. 25, 2025 (CN) 202510208920.0

(51) Int. Cl. G06F 3/0338; A63F 13/22; A63F 13/24

(52) U.S. Cl. CPC G06F 3/0338; A63F 13/22; A63F 13/24

(57) ABSTRACT

An adjustable-force joystick potentiometer includes a base, a rotating disc, a spring, a sliding disc, a joystick, an upper joystick arm, a lower joystick arm, a cover, a gear and a rotary shell. The base includes a cavity, the rotating disc is rotatably disposed in the cavity, each of the cavity and the rotating disc comprises an annular protrusion and an annular groove. When the rotating disc rotates, the rotating disc drives the annular protrusion and the annular groove to slide relative, thereby making the rotating disc rise or fall. The adjustable-force joystick potentiometer can adjust an operating force of the joystick by manually rotating and adjusting the shell.

### TECHNICAL FIELD

The disclosure relates to the technical field of potentiometers, and particularly to an adjustable-force joystick potentiometer (also referred to as joystick potentiometer with an adjustable operating force).

### BACKGROUND

A joystick potentiometer is a type of variable potentiometer suitable for joystick control handles used in gaming consoles, unmanned aerial vehicles (UAV), and similar devices. By manipulating a joystick of the joystick potentiometer, state changes of internal components of the gaming consoles, UAV, etc. can be controlled. Currently, operation force of the joystick potentiometer is unadjustable. It fails to tailor to required sensitivity of the game, leading to a poor user experience.

With the development of technology, an adjustable-force joystick potentiometer is gradually emerging, the adjustable-force joystick potentiometers can refer to Chinese patent with the publication No. CN215387510U, which discloses a joystick potentiometer. The joystick potentiometer includes a shell, a guide rod shaft rotatably disposed inside the shell, a control rod body sleeved on the guide rod shaft and slidingly connected to the guide rod shaft, a spring connected between the guide rod shaft and the control rod body, and a top end of the control rod body extends out of the shell. The joystick potentiometer further includes a lifting mechanism configured to lift the guide rod shaft upward. The lifting mechanism includes a lifting drive mechanism and a lifting block disposed between an output end of the lifting drive mechanism and an end of the guide rod shaft outside the control rod body. The lifting drive mechanism can be a linear motor or a rotary motor. The joystick potentiometer can drive the guide rod shaft and the control rod body to move relatively through the lifting mechanism, thereby adjusting a compression degree of an elastic element between the guide rod shaft and the control rod body. When user moves the control rod body, different force feedback will be felt. However, the technical problems existing in the joystick potentiometer are as follows: (1) A motor is required to drive the guide rod shaft to move up or down, and an overall drive structure of the joystick potentiometer is relatively complex and costly. Moreover, control software or control buttons are needed to control the operation of the motor. (2) The drive motor occupies a large space, especially in the limited space of the joysticks of game consoles, drones, etc., making it difficult to accommodate a large drive motor.

### SUMMARY

The technical problem to be solved by the disclosure is to address the shortcomings in the related art and provide an adjustable-force joystick potentiometer. The joystick potentiometer can adjust the operating force of the joystick by manually rotating and adjusting the shell. The component structure for adjusting the operating force of the joystick is simple, cost-effective, easy to use, stable, and occupies small space.

To solve above problems, an adjustable-force joystick potentiometer is provided. The adjustable-force joystick potentiometer includes a base, a rotating disc, a spring, a sliding disc, a joystick, an upper joystick arm, a lower joystick arm, a cover, a gear and a rotary shell. The base is defined with a cavity, the rotating disc is rotatably disposed in the cavity, one of the cavity and the rotating disc is provided with annular protrusions, and another of the cavity and the rotating disc is defined with annular grooves. The annular protrusions are disposed in the annular grooves, and each of the annular protrusions and the annular grooves includes a head end and a tail end. From the head end to the tail end of the each of the annular protrusions and the annular grooves, a height of the each of the annular protrusions and the annular grooves gradually increases. The annular protrusions are configured to slide relatively to the annular grooves when the rotating disc rotates to thereby make the rotating disc rise or fall. The spring is disposed on the rotating disc, the sliding disc is disposed on the spring, a side wall of the cavity of the base is provided with multiple guide feet, and the multiple guide feet extend in sliding engagement with a side of the sliding disc. The cover is disposed on the base, the joystick is disposed on the sliding disc, and the upper joystick arm and the lower joystick arm are sequentially disposed in the cover from top to bottom, and the joystick penetrates through the cover, the upper joystick arm, and the lower joystick arm and is connected to the lower joystick arm. The gear is disposed on the base, the rotary shell is rotatably disposed outside the cover, a lower end of the rotary shell is provided with an internal gear meshing with the gear, and the rotating disc is provided with an external gear meshing with the gear.

In an embodiment, the annular protrusions are disposed in the cavity, the annular grooves are defined at a bottom of the rotating disc, the head end of each of the annular protrusions is close to the tail end of each of the annular protrusions, and the head end of each of the annular grooves is close to the tail end of each of the annular grooves.

In an embodiment, the annular protrusions are two in number and the annular grooves are two in number, a diameter of one of the annular protrusions is less than that of another of the annular protrusions, an angle between the head ends of the annular protrusions and a center of the cavity is 180 degrees, and an angle between the tail ends of the annular protrusions and the center of the cavity is 180 degrees. A diameter of one of the annular grooves is less than that of another of the annular grooves, and an angle between the head ends of the annular grooves and the center of the cavity is 180 degrees, and an angle between the tail ends of the annular grooves and the center of the cavity is 180 degrees.

In an embodiment, a cavity center axis is disposed in the cavity, a center of the rotating disc defines a rotating disc shaft hole, and the rotating disc shaft hole is sleeved outside the cavity center axis. An upper end of the rotating disc is provided with a first spring seat, a lower end of the sliding disc is provided with a second spring seat, a bottom of the spring is disposed on the first spring seat, and a top of the spring is disposed under the second spring seat. Inner walls of the multiple guide feet of the base define guide grooves, respectively, and the side of the sliding disc is provided with guide strips respectively matching and sliding in the guide grooves.

In an embodiment, a lower end of the gear is provided with a gear shaft, and an upper end of the gear defines a gear circular hole. The base defines a gear shaft hole, the gear shaft is rotatably inserted into the gear shaft hole, a lower end of the cover is provided with a cover shaft, and the cover shaft extends downward into the gear circular hole.

In an embodiment, the rotary shell includes an upper rotary shell and a rotary gear shell, and the rotary gear shell is disposed on a lower end of the upper rotary shell. The internal gear is disposed on a lower end of an inner side of the rotary gear shell, a protruding ring is disposed on a middle of the inner side of the rotary gear shell, and the protruding ring is in sliding contact fit with an outer wall of the cover.

In an embodiment, the adjustable-force joystick potentiometer further includes a flexible flat cable (FPC) flexible circuit board. The FPC flexible circuit board is disposed on the base, and a first magnetic induction chip and a second magnetic induction chip are soldered on the FPC flexible circuit board. An end of the upper joystick arm is provided with a first permanent magnet, and the first permanent magnet and the first magnetic induction chip are positioned opposite to each other in a vertical direction and cooperate with each other through electromagnetic induction. An end of the lower joystick arm is provided with a second permanent magnet, and the second permanent magnet and the second magnetic induction chip are positioned opposite to each other in the vertical direction and cooperate with each other through electromagnetic induction.

In an embodiment, a dome switch is disposed on the FPC flexible circuit board, an upper end of the dome switch is provided with a pressing mechanism, and the pressing mechanism is disposed between adjacent two of the multiple guide feet of the base and configured to move up and down between the adjacent two of the multiple guide feet of the base. Another end of the lower joystick arm is disposed on an upper end of the pressing mechanism to press the dome switch via the pressing mechanism.

In an embodiment, the upper joystick arm includes an upper joystick arm main body and upper joystick arm shafts connected to two ends of the upper joystick arm main body, and the upper joystick arm shafts are rotatably connected to an inner wall of the cover. A lower end of one of the upper joystick arm shafts is provided with a first magnet positioning block, and the first permanent magnet is disposed in the first magnet positioning block. A center of the upper joystick arm main body defines an upper joystick arm center hole configured to make the joystick pass through. The lower joystick arm includes a lower joystick arm main body and lower joystick arm shafts connected to two ends of the lower joystick arm main body, and the lower joystick arm shafts are rotatably connected to the inner wall of the cover. A center of the lower joystick arm main body defines a lower joystick arm center hole configured to make the joystick pass through, and an inner wall of the lower joystick arm center hole is rotatably connected to the joystick. A lower end of another of the upper joystick arm shafts is provided with a second magnet positioning block, and the second permanent magnet is disposed in the second magnet positioning block.

In an embodiment, the adjustable-force joystick potentiometer further includes a dust cover, the joystick is connected to the dust cover and penetrates through an upper end of the dust cover, and a lower end of the dust cover is disposed between the rotary shell and the cover.

The beneficial effects of the disclosure are as follows.

The disclosure provides the rotating disc rotatably disposed in the cavity. One of the cavity and the rotating disc is provided with the annular protrusions, and another of the cavity and the rotating disc is defined with the annular grooves. The annular protrusions are disposed in the annular grooves, and each of the annular protrusions and the annular grooves includes a head end and a tail end. From the head end to the tail end of the each of the annular protrusions and the annular grooves, a height of the each of the annular protrusions and the annular grooves gradually increases. Thus, the annular protrusions are configured to slide relatively to the annular grooves when the rotating disc rotates to thereby make the rotating disc rise or fall. Specifically, the tail ends of the circular protrusions can gradually slide from the tail ends of the circular grooves toward its head ends, respectively, thereby lifting the rotating disc. Conversely, it can slide back from the head ends to the tail ends, thereby lowering the rotating disc. The spring is disposed on the rotating disc, and the sliding disc is disposed on the spring. The side wall of the cavity of the base is provided with the multiple guide feet, and the multiple guide feet extend in sliding engagement with the side of the sliding disc. The cover is disposed on the base, the joystick is disposed on the sliding disc, and the upper joystick arm and the lower joystick arm are sequentially disposed in the cover from top to bottom. The joystick penetrates through the cover, the upper joystick arm, and the lower joystick arm and is connected to the lower joystick arm. Therefore, when the rotating disc rises or descends, it can compress the spring upwards, increasing the force exerted by the spring on the sliding disc. Alternatively, it can release the spring downwards, reducing the force exerted by the spring on the sliding disc. This achieves the purpose of adjusting the operating force of the joystick. The gear is disposed on the base, and the rotary shell is rotatably disposed outside the cover. The lower end of the rotary shell is provided with an internal gear that meshes with the gear. The rotating disc is provided with an external gear that meshes with the gear. Therefore, when the rotary shell is manually rotated, the internal gear at its lower end drives the gear to rotate, which in turn drives the rotating disc to rotate. It can be seen that the disclosure can adjust the operating force or tactile feedback of the joystick by manually rotating the rotary shell. The components for adjusting the operating force or tactile feedback of the joystick have a simple structure, low cost, easy use, good stability, and small space occupation.

### BRIEF DESCRIPTION OF DRAWINGS

FIG. 1 illustrates an overall schematic structural view of an adjustable-force joystick potentiometer of the disclosure.

FIG. 2 illustrates a longitudinal sectional structural view of the adjustable-force joystick potentiometer of the disclosure.

FIG. 3 illustrates a schematic exploded view of the adjustable-force joystick potentiometer of the disclosure from a first perspective.

FIG. 4 illustrates a schematic exploded view of the adjustable-force joystick potentiometer of the disclosure from a second perspective.

FIG. 5 illustrates a schematic structural view of a combination of a base, a rotating disc, a spring, a sliding disc, a gear, a FPC flexible circuit board, and a pressing mechanism of the disclosure.

FIG. 6 illustrates a schematic structural view of the base of the disclosure.

FIG. 7 illustrates a schematic structural view of the rotating disc of the disclosure.

FIG. 8 illustrates a schematic structural view of the FPC flexible circuit of the disclosure.

### DETAILED DESCRIPTION OF EMBODIMENTS

The following will further explain the structural and working principles of the disclosure in detail with reference to the attached drawings.

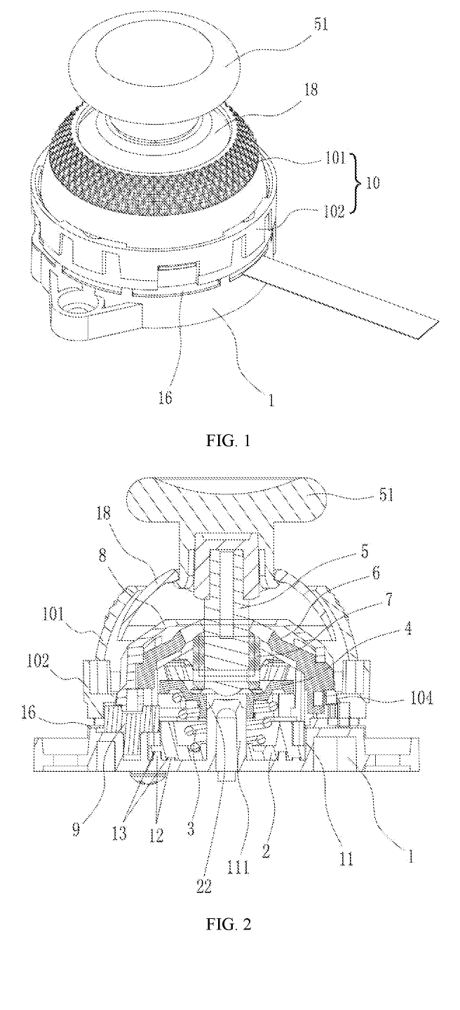

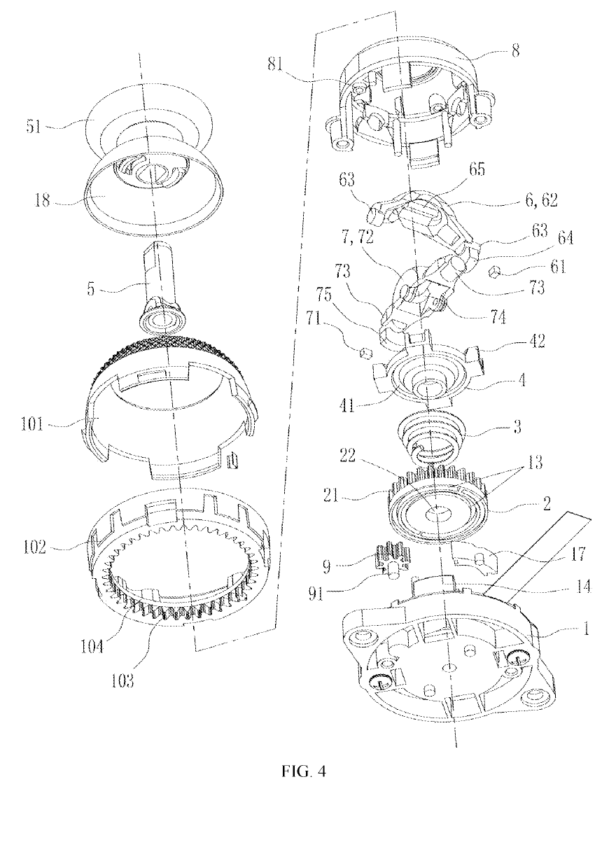

In an embodiment, as shown in FIGS. 1 to 5, an adjustable-force joystick potentiometer is provided. The adjustable-force joystick potentiometer includes a base 1, a rotating disc 2, a spring 3, a sliding disc 4, a joystick 5, an upper joystick arm 6, a lower joystick arm 7, a cover 8, a gear 9, and a rotary shell 10. The base 1 is defined with a cavity 11, the rotating disc 2 is rotatably disposed in the cavity 11. The cavity 11 is provided with annular protrusions 12, and a bottom of the rotating disc 2 is defined with annular grooves 13, and the annular protrusions 12 are disposed in the annular grooves 13, respectively. It should be noted that positions of the annular protrusions and the annular grooves can also be interchanged in the disclosure. That is, the annular grooves can be defined in the cavity 11 and the annular protrusions can be disposed on the bottom of the rotating disc 2, with the same functional effect. Each of the annular protrusions 12 and the annular grooves 13 includes a head end 121, 131 and a tail end 122, 132, and a height of the each of the annular protrusions 12 and the annular grooves 13 gradually increases from the head end 121, 131 to the tail end 122, 132. The annular protrusions 12 are configured to slide relatively to the annular grooves 13 when the rotating disc 2 rotates to thereby make the rotating disc 2 rise or fall. The spring 3 is disposed on the rotating disc 2, and the sliding disc 4 is disposed on the spring 3. A side wall of the cavity 11 of the base 1 is provided with several guide feet 14, and the guide feet 14 extend in sliding engagement with a side of the sliding disc 4. The cover 8 is disposed on the base 1, and the joystick 5 is disposed on the sliding disc 4. The upper joystick arm 6 and the lower joystick arm 7 are sequentially disposed in the cover 8 from top to bottom, and the joystick 5 penetrates through the cover 8, the upper joystick arm 6, and the lower joystick arm 7 and is connected to the lower joystick arm 7. The gear 9 is disposed on the base 1, and the rotary shell 10 is rotatably disposed outside the cover 8. A lower end of the rotary shell 10 is provided with an internal gear 103, which mesh with the gear 9. The rotating disc 2 is provided with an external gear 21, which also meshes with the gear 9.

A method for adjusting the operating force of the adjustable-force joystick potentiometer in the disclosure includes methods for increasing and decreasing the operating force of the joystick: (1) When it is necessary to increase the operating force of the joystick 5, the rotary shell 10 is rotated clockwise. The internal gear 103 of the rotary shell 10 drives the gear 9 to rotate clockwise, which in turn drives the rotating disc 2 to rotate counterclockwise. The tail ends of the annular protrusions 12 gradually slides from the tail ends of the annular grooves 13 towards the head ends of the annular grooves 13, respectively, thereby causing the rotating disc 2 to rise gradually within the cavity 11. The rotating disc 2 compresses the spring 3 upwards, increasing the force exerted by the spring 3 on the sliding disc 4. As a result, during a tilting operation of the joystick 5, a greater operating force is required to slide the sliding disc 4 downwards. (2) When it is necessary to decrease the operating force of the joystick 5, the rotary shell 10 is rotated counterclockwise. The internal gear 103 of the rotary shell 10 drives the gear 9 to rotate counterclockwise, which in turn drives the rotating disc 2 to rotate clockwise. The tail ends of the annular protrusions 12 gradually slides back from the head ends of the annular grooves 13 to the tail ends of the annular grooves 13, respectively, thereby causing the rotating disc 2 to descend gradually within the cavity 11. The rotating disc 2 releases the spring 3 downwards, reducing the force exerted by the spring 3 on the sliding disc 4. As a result, during the tilting operation of the joystick 5, a smaller operating force is sufficient to slide the sliding disc 4 downwards. The adjustable-force joystick potentiometer provided by the disclosure allows for an adjustment of the operating force or tactile feedback of the joystick by manually rotating the rotary shell. The components for adjusting the operating force or tactile feedback of the joystick have a simple structure, low cost, easy use, good stability, and small space occupation.

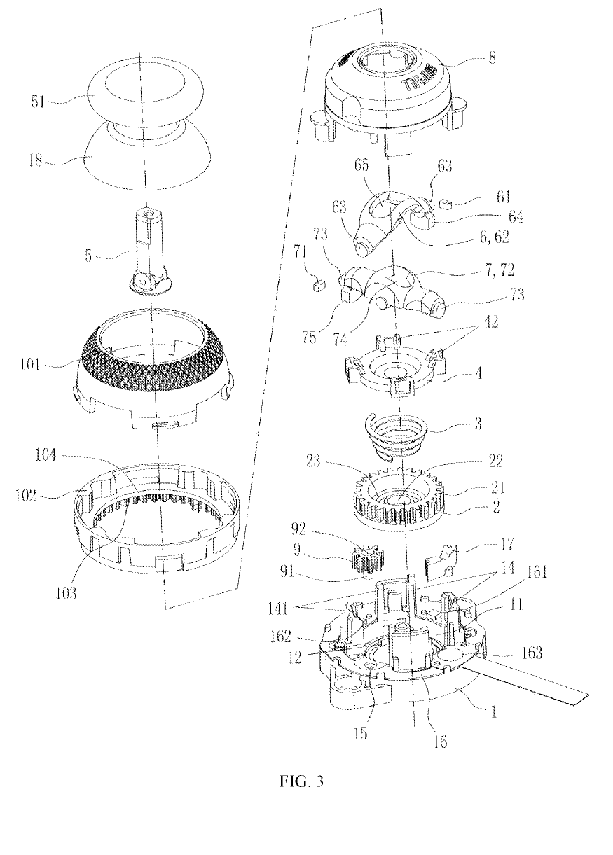

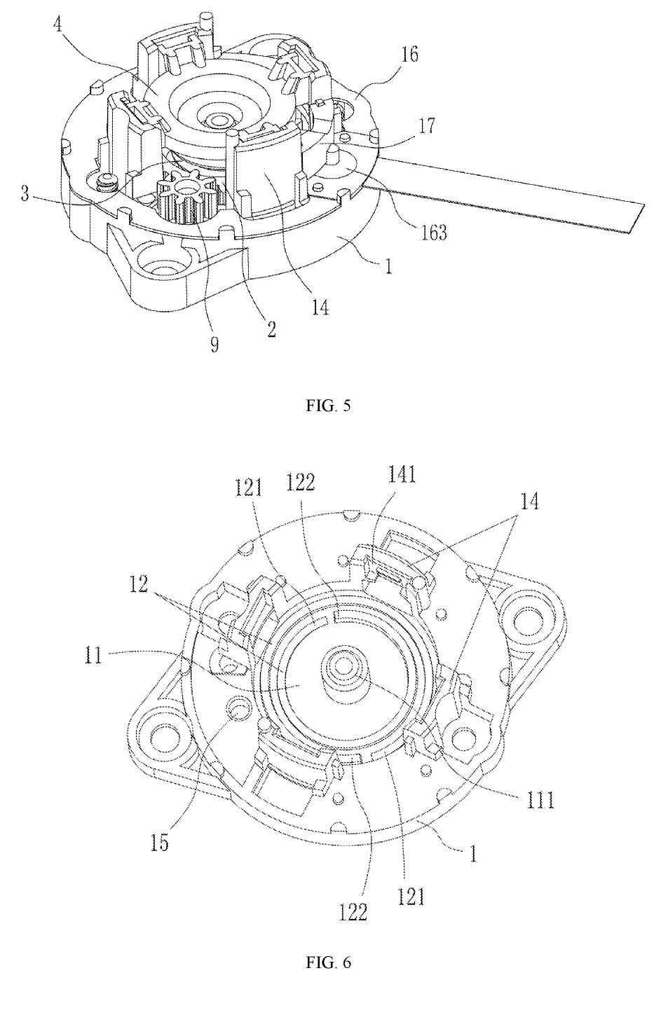

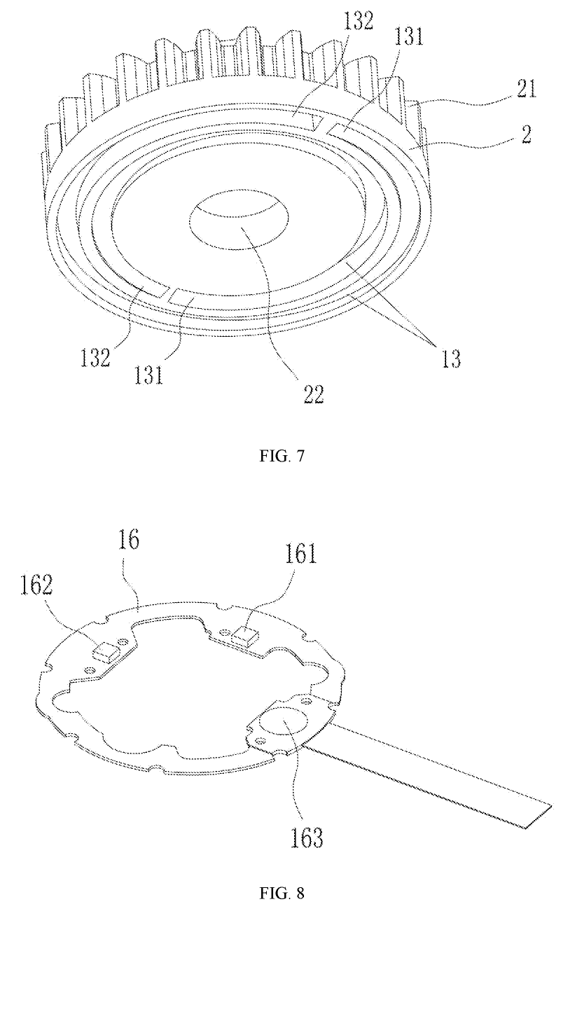

As shown in FIGS. 3-4 and 6-7, the head ends 121 of the annular protrusions 12 are close to the tail ends 122 of the annular protrusions 12, respectively, and the head ends 131 of the annular grooves 13 are close to the tail ends 132 of the annular grooves 132, respectively. During a process of increasing the operating force of the joystick 5, the tail ends of the annular protrusions 12 gradually slides from the tails end 131 of the annular grooves 13 towards the head end 132 of the annular grooves 13. When the tail ends 122 of the annular protrusions 12 reach positions of the head ends 131 of the annular grooves 13, the rotating disc 2 reaches its highest position, at which point the operating force of the joystick 5 is maximized. If the rotary shell 10 continues to be rotated clockwise, due to proximity of the head ends 121 and tail ends 122 of the annular protrusions 12 and proximity of the head ends 131 and tail ends 132 of the annular grooves 13, the tail ends 122 of the annular protrusions 12 will directly jump from the head ends 131 of the annular grooves 13, respectively, into the tail end 132 of the annular grooves 13. This causes the rotating disc 2 to instantly return to its lowest position, at which point the operating force of the joystick 5 is minimized. During the process of increasing the operating force of the joystick 5, this structure of the disclosure prevents the problem of users continuously applying force to rotate the rotary shell 10, thereby avoiding potentially damage the joystick potentiometer.

As shown in FIGS. 2-4 and 6-7, the annular protrusions 12 are two in number, and the annular grooves 13 are two in number, a diameter of one of the annular protrusions 12 is less than that of another of the annular protrusions 12, an angle between the head ends 121 of the annular protrusions 12 and a center of the cavity 11 is 180 degrees, and an angle between the tail ends 122 of the annular protrusions 12 and the center of the cavity is 180 degrees. A diameter of one of the annular grooves 13 is less than that of another of the annular grooves 13, and an angle between the head ends 131 of the annular grooves 13 and the center of the cavity 11 is 180 degrees, and an angle between the tail ends 132 of the annular grooves 13 and the center of the cavity 11 is 180 degrees.

This structure ensures that the cavity 11 always has two support zones for the rotating disc 2, which are symmetrically positioned based on the center. This design improves the balance and stability of the support.

As shown in FIGS. 3-4 and 6-7, a cavity center axis 111 is disposed in the cavity 11, a center of the rotating disc 2 defines a rotating disc shaft hole 22, and the rotating disc shaft hole 22 is sleeved outside the cavity center axis 111 and can move up or down along the cavity center axis 111. An upper end of the rotating disc 2 is provided with a first spring seat 23, a lower end of the sliding disc 4 is provided with a second spring seat 41, a bottom 3 of the spring is disposed on the first spring seat 23, and a top of the spring 3 is disposed under the second spring seat 41. Inner walls of the guide feet 14 of the base 1 define guide grooves 141, respectively, and the side of the sliding disc 4 is provided with guide strips 42 respectively matching and sliding in the guide grooves 141.

As shown in FIGS. 2-6, a lower end of the gear 9 is provided with a gear shaft 91, and an upper end of the gear 9 defines a gear circular hole 92. The base 1 defines a gear shaft hole 15, the gear shaft 91 is rotatably inserted into the gear shaft hole 15, a lower end of the cover 8 is provided with a cover shaft 81, and the cover shaft 81 extends downward into the gear circular hole 92.

As shown in FIGS. 1-4, the rotary shell 10 includes an upper rotary shell 101 and a rotary gear shell 102, and the rotary gear shell 102 is disposed on a lower end of the upper rotary shell 101. The internal gear 103 is disposed on a lower end of an inner side of the rotary gear shell 102, a protruding ring 104 is disposed on a middle of the inner side of the rotary gear shell 102, and the protruding ring 104 is in sliding contact fit with an outer wall of the cover 8. The protruding ring 104 ensures that there is sufficient spacing between the rotary shell 10 and the cover 8 as a whole. Meanwhile, the protruding ring 104 enables the rotary shell 10 to rotate stably outside the lower end of the cover 8.

As shown in FIGS. 1-5, and 8, the adjustable-force joystick potentiometer further includes a FPC flexible circuit board 16. The FPC flexible circuit board 16 is disposed on the base 1, and a first magnetic induction chip 161 and a second magnetic induction chip 162 are soldered on the FPC flexible circuit board 16. An end of the upper joystick arm 6 is provided with a first permanent magnet 61, and the first permanent magnet 61 and the first magnetic induction chip 161 are positioned opposite to each other in a vertical direction and cooperate with each other through electromagnetic induction. An end of the lower joystick arm 7 is provided with a second permanent magnet 71, and the second permanent magnet 71 and the second magnetic induction chip 162 are positioned opposite to each other in the vertical direction and cooperate with each other through electromagnetic induction As the joystick tilts and swings, it drives the upper joystick arm and the lower joystick arm to move, causing the first and second magnetic induction chips to detect changes in magnetic field strength of the first and second permanent magnets and to output induction signals. This design ensures high accuracy in sensing.

As shown in FIGS. 3-5, and 8, a dome switch 163 is disposed on the FPC flexible circuit board 16, an upper end of the dome switch 163 is provided with a pressing mechanism 17, and the pressing mechanism 17 is disposed between adjacent two of the guide feet 14 of the base 1 and configured to move up and down between the adjacent two of the guide feet 14 of the base 1. Another end of the lower joystick arm 7 is disposed on an upper end of the pressing mechanism 17 to press the dome switch 163 via the pressing mechanism 17.

As shown in FIGS. 3-5, the upper joystick arm 6 includes an upper joystick arm main body 62 and upper joystick arm shafts 63 connected to two ends of the upper joystick arm main body 62, and the upper joystick arm shafts 63 are rotatably connected to an inner wall of the cover 8. A lower end of one of the upper joystick arm shafts 63 is provided with a first magnet positioning block 64, and the first permanent magnet 61 is disposed in the first magnet positioning block 64. A center of the upper joystick arm main body 62 defines an upper joystick arm center hole 65 configured to make the joystick 5 pass through. The lower joystick arm 7 includes a lower joystick arm main body 72 and lower joystick arm shafts 73 connected to two ends of the lower joystick arm main body 72, and the lower joystick arm shafts 73 are rotatably connected to the inner wall of the cover 8. A center of the lower joystick arm main body 72 defines a lower joystick arm center hole 74 configured to make the joystick 5 pass through, and an inner wall of the lower joystick arm center hole 74 is rotatably connected to the joystick 5. A lower end of another of the upper joystick arm shafts 63 is provided with a second magnet positioning block 75, and the second permanent magnet 71 is disposed in the second magnet positioning block 75.

As shown in FIGS. 1-5, the adjustable-force joystick potentiometer further includes a dust cover 18, the joystick 5 is connected to the dust cover 18 and penetrates through an upper end of the dust cover 18, a lower end of the dust cover 18 is disposed between the rotary shell 10 and the cover 8, and the top end of the joystick 5 is also provided with a joystick cap 51.

The above is only a specific embodiment of the disclosure. Any minor modifications, equivalent changes, and modifications made to the above embodiments based on the technical solution of the disclosure are within the scope of the technical solution of the disclosure.

What is claimed is:

1. An adjustable-force joystick potentiometer, comprising:
a base, a rotating disc, a spring, a sliding disc, a joystick, an upper joystick arm, a lower joystick arm, a cover, a gear, and a rotary shell;
wherein the base is defined with a cavity, the rotating disc is rotatably disposed in the cavity, one of the cavity and the rotating disc is provided with annular protrusions, and another of the cavity and the rotating disc is defined with annular grooves; the annular protrusions are disposed in the annular grooves, and each of the annular protrusions and the annular grooves comprises a head end and a tail end; from the head end to the tail end of the each of the annular protrusions and the annular grooves, a height of the each of the annular protrusions and the annular grooves gradually increases; the annular protrusions are configured to slide relatively to the annular grooves when the rotating disc rotates to thereby make the rotating disc rise or fall; the spring is disposed on the rotating disc, the sliding disc is disposed on the spring, a side wall of the cavity of the base is provided with a plurality of guide feet, and the plurality of guide feet extend in sliding engagement with a side of the sliding disc; the cover is disposed on the base, the joystick is disposed on the sliding disc, and the upper joystick arm and the lower joystick arm are sequentially disposed in the cover from top to bottom, and the joystick penetrates through the cover, the upper joystick arm, and the lower joystick arm and is connected to the lower joystick arm; the gear is disposed on the base, the rotary shell is rotatably disposed outside the cover, a lower end of the rotary shell is provided with an internal gear meshing with the gear, and the rotating disc is provided with an external gear meshing with the gear.

2. The adjustable-force joystick potentiometer as claimed in claim 1, wherein the annular protrusions are disposed in the cavity, the annular grooves are defined at a bottom of the rotating disc, the head end of each of the annular protrusions is close to the tail end of each of the annular protrusions, and the head end of each of the annular grooves is close to the tail end of each of the annular grooves.

3. The adjustable-force joystick potentiometer as claimed in claim 1, wherein the annular protrusions are two in number, the annular grooves are two in number, a diameter of one of the annular protrusions is less than that of another of the annular protrusions, an angle between the head ends of the annular protrusions and a center of the cavity is 180 degrees, and an angle between the tail ends of the annular protrusions and the center of the cavity is 180 degrees; a diameter of one of the annular grooves is less than that of another of the annular grooves, and an angle between the head ends of the annular grooves and the center of the cavity is 180 degrees, and an angle between the tail ends of the annular grooves and the center of the cavity is 180 degrees.

4. The adjustable-force joystick potentiometer as claimed in claim 1, wherein a cavity center axis is disposed in the cavity, a center of the rotating disc defines a rotating disc shaft hole, and the rotating disc shaft hole is sleeved outside the cavity center axis; an upper end of the rotating disc is provided with a first spring seat, a lower end of the sliding disc is provided with a second spring seat, a bottom of the spring is disposed on the first spring seat, and a top of the spring is disposed under the second spring seat; inner walls of the plurality of guide feet of the base define guide grooves, respectively, and the side of the sliding disc is provided with guide strips respectively matching and sliding in the guide grooves.

5. The adjustable-force joystick potentiometer as claimed in claim 1, wherein a lower end of the gear is provided with a gear shaft, and an upper end of the gear defines a gear circular hole; the base defines a gear shaft hole, the gear shaft is rotatably inserted into the gear shaft hole, a lower end of the cover is provided with a cover shaft, and the cover shaft extends downward into the gear circular hole.

6. The adjustable-force joystick potentiometer as claimed in claim 1, wherein the rotary shell comprises an upper rotary shell and a rotary gear shell, and the rotary gear shell is disposed on a lower end of the upper rotary shell; the internal gear is disposed on a lower end of an inner side of the rotary gear shell, a protruding ring is disposed on a middle of the inner side of the rotary gear shell, and the protruding ring is in sliding contact fit with an outer wall of the cover.

7. The adjustable-force joystick potentiometer as claimed in claim 1, further comprising: a flexible flat cable (FPC) flexible circuit board; wherein the FPC flexible circuit board is disposed on the base, and a first magnetic induction chip and a second magnetic induction chip are soldered on the FPC flexible circuit board; an end of the upper joystick arm is provided with a first permanent magnet, and the first permanent magnet and the first magnetic induction chip are positioned opposite to each other in a vertical direction and cooperate with each other through electromagnetic induction; and an end of the lower joystick arm is provided with a second permanent magnet, and the second permanent magnet and the second magnetic induction chip are positioned opposite to each other in the vertical direction and cooperate with each other through electromagnetic induction.

8. The adjustable-force joystick potentiometer as claimed in claim 7, wherein a dome switch is disposed on the FPC flexible circuit board, an upper end of the dome switch is provided with a pressing mechanism, and the pressing mechanism is disposed between adjacent two of the plurality of guide feet of the base and configured to move up and down between the adjacent two of the plurality of guide feet of the base; another end of the lower joystick arm is disposed on an upper end of the pressing mechanism to press the dome switch via the pressing mechanism.

9. The adjustable-force joystick potentiometer as claimed in claim 7, wherein the upper joystick arm comprises an upper joystick arm main body and upper joystick arm shafts connected to two ends of the upper joystick arm main body, and the upper joystick arm shafts are rotatably connected to an inner wall of the cover; a lower end of one of the upper joystick arm shaft is provided with a first magnet positioning block, and the first permanent magnet is disposed in the first magnet positioning block; a center of the upper joystick arm main body defines an upper joystick arm center hole configured to make the joystick pass through; the lower joystick arm comprises a lower joystick arm main body and lower joystick arm shafts connected to two ends of the lower joystick arm main body, and the lower joystick arm shafts are rotatably connected to the inner wall of the cover; a center of the lower joystick arm main body defines a lower joystick arm center hole configured to make the joystick pass through, and an inner wall of the lower joystick arm center hole is rotatably connected to the joystick; a lower end of another of the upper joystick arm shafts is provided with a second magnet positioning block, and the second permanent magnet is disposed in the second magnet positioning block.

10. The adjustable-force joystick potentiometer as claimed in claim 7, further comprising: a dust cover, wherein the joystick is connected to the dust cover and penetrates through an upper end of the dust cover, and a lower end of the dust cover is disposed between the rotary shell and the cover.
